(19) United States
(12) Patent Application Publication
(10) Pub. No.: US 2019/0261010 A1
(43) Pub. Date: Aug. 22, 2019

(54) METHOD AND SYSTEM OF VIDEO CODING WITH REDUCED SUPPORTING DATA SIDEBAND BUFFER USAGE

(71) Applicant: Intel Corporation, Santa Clara, CA (US)

(72) Inventors: Ning Luo, Shanghai (CN); Changliang Wang, Bellevue, WA (US); Bo Zhao, Shanghai (CN); Yue Xiong, Shanghai (CN)

(73) Assignee: Intel Corporation, Santa Clara, CA (US)

(21) Appl. No.: 16/342,110

(22) PCT Filed: Nov. 21, 2016
(86) PCT No.: PCT/CN2016/106589

§ 371 Date: Apr. 15, 2019

(51) Int. Cl. H04N 19/423; H04N 19/119; H04N 19/40; H04N 19/186; H04N 19/176

(52) U.S. Cl. CPC H04N 19/423; H04N 19/119; H04N 19/176; H04N 19/186; H04N 19/40

(57) ABSTRACT

Methods, systems, and articles of video coding with reduced supporting data sideband buffer usage.

### BACKGROUND

Many different types of video coding transmission systems use a transcoder along the transmission pathway. In one example, video on demand (VOD) services that allow a user to record a television show to be watched later (catch-up TV service) or rewind the show during broadcast to restart a show (start-over TV service) may transmit videos from a television network and to a remote digital video recorder (DVR) server that has a transcoder. The transcoder may have a decoder to receive compressed video data and decompresses the video data, and then the transcoder's encoder may re-compress and format the video data for transmission to end devices such as a television, smartphone, cable box, and so forth. After decompression, the transcoder stores the image data, including chroma and luminance (or luma) pixel values when a YUV type of color space is being used, and stores supporting data used to decode the image data such as prediction data including motion vector data, the selected prediction modes, and so forth.

The supporting data used at the decoder is saved so that the encoder can re-use the supporting data to optimize motion estimation and prediction mode selection for example so that motion vectors and the mode prediction selection do not need to be calculated (or the number of computations performed to make such determinations may be reduced). The saved supporting data may be stored in a motion vector and/or prediction mode buffer so that this supporting data may be accessible to the transcoder's encoder via a sideband. The memory bandwidth consumed to perform write and read transactions with the motion vector and/or prediction mode (MV/PM) buffer can be extremely large, especially with ultra high definition (UHD), high dynamic range (HDR) video resulting in an inefficient video coding system that could better use the memory bandwidth for other tasks potentially increasing the speed of the system and/or the quality of the video. Thus, such video coding, which is a fundamental function of computers and computing devices, could be made more efficient by reducing or eliminating memory bandwidth consumed for such supporting data at a sideband buffer.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Furthermore, where considered appropriate, reference labels have been repeated among the figures to indicate corresponding or analogous elements. In the figures:

FIG. 1 is a schematic diagram of a video transmission network that uses a transcoder and video coding according to the implementations herein;

FIG. 2 is a simplified schematic diagram of a transcoder according to the implementations herein;

FIG. 3 is a schematic diagram of a transcoder according to the implementations herein;

FIG. 4 is a flow chart of a method of video coding with reduced supporting data sideband buffer usage and from the decoder side according to the implementations herein;

FIG. 5 is a flow chart of another method of video coding with reduced supporting data sideband buffer usage and from the encoder side according to the implementations herein;

FIG. 6 is another flow chart of a method of video coding with reduced supporting data sideband buffer usage and from the decoder side according to the implementations herein;

FIG. 7 is a schematic diagram of image data layout and memory structure according to the implementations herein;

FIG. 8 is another flow chart of a method of video coding with reduced supporting data sideband buffer usage and from the encoder side according to the implementations herein;

FIG. 9 is an illustrative diagram of an example system in operation for providing a method of video coding with reduced supporting data sideband buffer usage according to the implementations herein;

FIG. 10 is an illustrative diagram of an example system;

FIG. 11 is an illustrative diagram of another example system; and

FIG. 12 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices such as gateways, and/or consumer electronic (CE) devices such as set top (or cable) boxes, smart phones, tablets, televisions, etc., may implement the techniques and/or arrangements described herein. Furthermore, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof unless specified herein. The material disclosed herein also may be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Furthermore, when a particular feature, structure, or characteristic is described in connection with an implementation, it is submitted that it is within the knowledge of one skilled in the art to effect such feature, structure, or characteristic in connection with other implementations whether or not explicitly described herein.

Systems, articles, and methods are described below related to video coding with reduced supporting data sideband buffer usage according to the implementations herein.

As mentioned, many video coding networks have transcoders with a decoder that receives compressed image data in the form of a video frame sequence to be decompressed. The decoder saves the de-compressed image data as well as supporting data used to reconstruct the de-compressed frames. The supporting data may be saved in a sideband buffer reserved for the supporting data, and the supporting data may include prediction data such as motion vector data and/or prediction mode selections, but could include other data as explained below. A prediction of a block of pixel data of a frame is subtracted from the original block of image data to determine residuals. The residuals are then compressed and transmitted to a decoder rather than compressing the original pixel data of each frame.

In more detail, motion estimation (ME) during the decoding loop in an encoding stage usually consumes the largest amount of computations of any of the main operations during encoding. Motion estimation includes a search for a block of pixels on one or more reference frames that best matches a current frame being compressed. A prediction mode selection is performed when multiple candidate predictions are provided for a block to be compressed, and this may include inter-prediction, intra-prediction and/or other candidates. The selected prediction mode is used to determine the residual to be compressed. These computations are computationally heavy as mentioned above. Thus, one widely-adopted optimization is to leverage the MV/Mode information generated in a transcoder decoding phase to optimize the motion estimation and mode decision in the following encoding sessions. The sideband buffer permits the decoder to pass the supporting data to the transcoder's encoder so that the encoder does not need to re-calculate the supporting data (when the saved motion vectors and/or prediction mode may be used instead), or may at least reduce the amount of computation needed to form the supporting data at the encoder. For example, the saved motion vector may indicate a smaller area for block matching searches by the encoder to generate a final motion vector.

Also as mentioned, the memory bandwidth consumed to write the supporting data to the sideband buffer and then to read the supporting data for use by the encoder can be extremely large. This is particularly true with high or ultra-high definition video that uses high dynamic range (HDR) video and other high quality formats. Specifically, in the pipeline of a 1 to N HDR video coding system with just-in-time transcoding, one unique copy is received and with HDR content formatted in highly efficient video coding (HEVC) with a Main 10 profile of highest resolution as one example. This unique copy may be transcoded into N different video coding formats including different resolutions, bitrates, codec format, frame rate, and other characteristics where each change may require its own encoding session (which also may be referred to as an enhancement layer or level). A decoder at an end device may receive a bitstream (or multiple bitstreams) with multiple compressed video data in alternative formats, and the decoder at the end device may select the video with a compatible desired format. In this case, the encoder at the transcoder reads the video image data and the supporting data from the sideband buffer N times, one for each encoding session. It should be noted that herein the phrase image data usually refers to the chroma or luma pixel values rather than any other supporting data that might be stored for coding the image data, unless the context suggests otherwise.

In one conventional advanced video coding (AVC) decoder, the graphics processing unit (GPU) hardware generated MV/Mode information uses 64 bytes for each 16×16 macroblock. So if the sideband MV/Mode buffer is used, the following memory bandwidth consumption results. In a 2160p@60 fps (4K UHD) transcoding case, the memory access to the sideband buffer will cost 120 MB/s write bandwidth (after the decoding session) and 120 * N MB/s read bandwidth (120 MB/s for each encoding session). In a 4320p@60 fps (8K UHD) transcoding case, the memory access to the sideband buffer will cost 480 MB/s extra write bandwidth (for the decoding session) and 480 *N MB/s extra read bandwidth (480 MB/s for each encoding session). Thus, in the case of a broadcast media server, it is very common to have more than 16 encoding sessions activated simultaneously where each session consumes the memory bandwidth just described, and therefore, the memory bandwidth cost just mentioned can easily reach several GB/s.

To resolve these issues, a transcoder on a video transmission or video coding network may reduce or eliminate the use of the sideband buffer that stores supporting data such as the prediction data by embedding the supporting data into the pixel image data fields of frames of a video frame sequence where the pixel luma and/or chroma data is stored. It should be noted the term luma and luminance herein are used interchangeably in the general sense unless context suggests otherwise, and both refer to brightness or intensity components or values in a YUV type of color space with one luma or brightness component and two color or chroma components despite technical definitions regarding analog versus digital definitions, spectral versus electronic definitions, gamma spectrum influence, specific file or video format which may be YCbCr, using Y′ to refer to luma, or other technical or related definitions. The prediction data may include motion vectors used during inter-prediction at the decoder to reconstruct the frames of a video sequence being decoded. The prediction data also may include the prediction mode selection used by the decoder to determine which one of the candidate predictions to use as the final prediction no matter which way a prediction was generated, whether intra-prediction, inter-prediction, or other method. Other types of supporting data could be included as well.

The supporting data is placed in pixel image data fields that each hold a luma or chroma value for a frame in a video frame sequence. By one form, it is sufficient to fill the luma component blocks first before using the chroma blocks. For a conventional YUV format structure, the coders store a Y luma value and two chroma values, U and V, for each macroblock of 16×16 pixels. Specifically, the luma values are organized as 16×16 pixel macroblocks so that each or some sampling of pixels have a luma value. The chroma values are also arranged in blocks of data for the macroblock, and depends on the chroma sampling scheme used, such as 4:4:4 (16×16 blocks of chroma values), 4:2:2 (16×8 blocks of chroma values), or 4:2:0 (8×8 blocks of chroma values). These schemes also may be referred to as P410, P210, and P010 respectively for high dynamic range that generates a maximum value of 1023 per luma or chroma value which is a 10 bit value in binary.

Each pixel is assigned a pixel image data field for storing each individual luma and chroma value. For memory alignment, however, each pixel image data field is stored as a 16 bit field for HDR whether or not the luma or chroma value fills that field. Thus, for example, when a 10 bit HDR value is being used for luma, six of the sixteen bits in the pixel image data field is held in reserve in a reserve area that was previously kept empty. Other options may occur such as a 12 bit HDR UHD value (with a maximum luminance value of 4095) with 4 reserve bits or spaces in the 16 bit field. During conventional memory transactions, a write to, and read from, the these pixel image data fields in memory when storing or fetching the pixel luma or chroma value will perform a 16 bit memory access (or bandwidth) to respectively write or read all 16 bit places in the pixel image data field anyway, even the empty reserve spaces. The present system and methods take advantage of the wasted time and memory bandwidth writing to or reading from the reserved spaces in the pixel image data fields by embedding the supporting data, including prediction data by one example, in the reserve spaces, thereby reducing, or eliminating, the need for a separate supporting data sideband buffer used to store the supporting data. The supporting data may be prediction data including the motion vector magnitude as well as prediction mode selection of a certain block of pixel image data, where the prediction data is divided into pieces that fit in the reserve bit areas of the pixel image data fields as described in detail below. The supporting data may additionally or alternatively include other types of support data as described below. At the encoder side, the prediction data is extracted from the pixel image data fields of the image data just decoded, and reconstructed by joining, or concatenating, the separate pieces of the supporting to form full prediction data values. The prediction data is then used to encode the pixel image data for transmission to a remote decoder or display for example. The details are provided below.

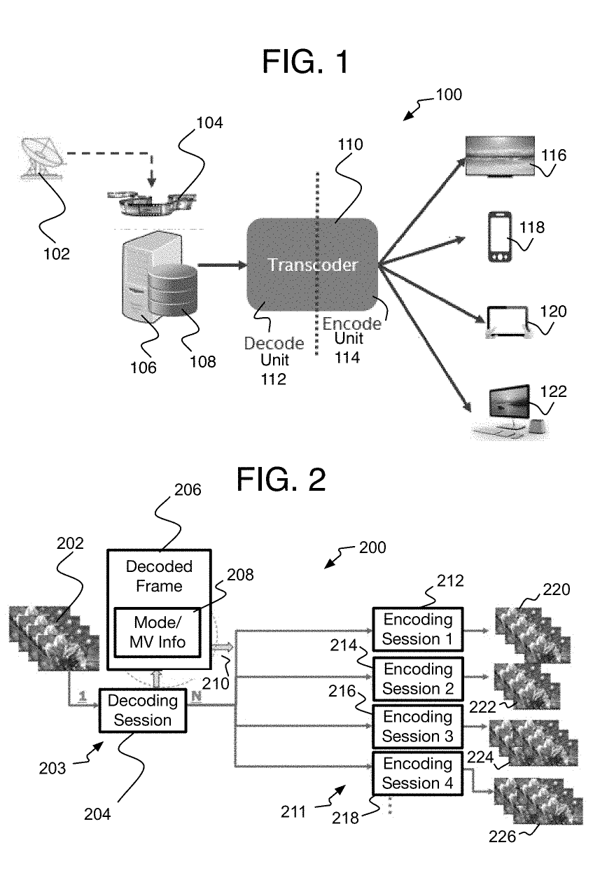

Referring to FIG. 1, a video transmission network or system 100 is provided to implement the methods that perform video coding with reduced or even eliminated use of a supporting data sideband buffer. The network 100 may include a broadcaster 102 that broadcasts videos 104 such as movies, television shows, or any other videos of frame sequences over a computer network such as a wide area network (WAN) including the internet, a local area network (LAN), or any other network that wired or wirelessly transmits video frame sequences.

By one example, the pipeline of the network 100 is configured to handle multi-screen HDR VOD catch-up or start-over TV services. This involves storing one unique copy of the HDR content at a database 108 on a cloud digital video recording (DVR) service or remote server 106. This may be some centralized storage of a service provider that is used by many subscribers to a cable television service for example. Also by this example, the video may be provided in many different high quality video formats such as HEVC Main 10 profile and in the highest resolution supported by the profile. This permits the video to be independently displayed on multiple devices with different video format requirements or desired settings.

The network 100 also may include a transcoder 110, and by one form, a UHD just-in-time 1 to N transcoder that has a decoder unit 112 that decodes compressed image data of frames of a frame sequence of a video (also referred to herein as a video sequence) at the remote server 106, and then uses an encoder unit 114 to encode the video sequence formatted to be compatible with multiple end devices for display of the video sequence. In one form, the transcoder 110 is located at the site of the server 106 (or is on server 106) and transmits the multiple encoded frame sequences, whether as a single bitstream or multiple bitstreams, to end devices. By other forms, the transcoder may be at the location of the end devices, where for example, the transcoder may be part of a business or residential gateway, set-top box (cable box), and so forth that then transmits multiple encoded video sequences of different formats to different devices. The transcoder may even be located on one of the end devices itself such as a smartphone to form a personal area network (PAN). Such a transcoder may receive a single compressed version of a video sequence, and then provides bitstreams of the video sequence re-compressed in multiple different formats. By some example arrangements, a large screen television 116 may receive the video sequence formatted for HEVC 4K or 8K 60 fps video, a smartphone 118 may receive the video sequence formatted for HEVC 720p 30 fps video, a tablet 120 may receive the video sequence formatted for 1080p HD 30 fps video, and a desk top or laptop computer 122 may receive the video sequence formatted for advanced video coding (AVC) 1080p 30 fps video. These are one of many possible example arrangements.

Referring to FIG. 2, a simplified example of an image or video processing device or transcoder 200 may be used to perform the methods of video coding with reduced supporting data sideband buffer usage as described herein. The system 200 may receive image data of a video frame sequence 202 where the image data of each video frame includes YUV values (which may or may not have been converted from RGB values), and by one form in HDR. The transcoder 200 may be a 1 to N transcoder to provide a single video in alternative video formats.

Specifically, the transcoder 200 may include establishment of a decoding session 204 by a decoder 203 that decodes the single received compressed video received in a bitstream, and that uses motion vectors to establish candidate predictions. The motion vectors may be obtained from initial supporting data received in the bitstream with the image data. The decoding session 204 provided by the decoder 203 then determines a prediction mode for individual blocks, slices, frames, or other units of data on a frame of the image data, and frame by frame. The desired prediction mode also may be provided in the initial supporting data. The de-compressed image data is then saved in pixel image data fields, of 16 bits for example, where it is accessible to an encoder 211 of the transcoder 200.

Once a prediction mode is selected for reconstructing a frame that prediction mode may be saved or otherwise placed into the reserve area of the pixel image data fields. Likewise, when the selected prediction mode is inter-prediction, the motion vector used for the relevant block of data alternatively or additionally is placed in the previously empty reserve area of the pixel image data fields. As shown then, the supporting data 208, including the prediction data such as the prediction mode and motion vector information, may be placed with the image data of a decoded frame 206, such as in a non-compressed image data buffer. As described below, this may involve concatenating the supporting data and then dividing the supporting data into pieces that will fit into the reserve areas of the pixel image data fields. The details are provided below (see FIG. 7 for example).

Next, the transcoder 200 may have one or more encoders to establish multiple individual encoding sessions, one for each video format alternative that needs its own encoding session to generate video image data with a desired format. The encoder(s) may retrieve the decoded frame 206 along with the supporting data 208 embedded therein. This may be performed N times, one time for each encoding session that is to be established. The supporting data 208 may be extracted or read for each block or other unit of data on a frame that is to use inter-prediction or otherwise establish a prediction mode used to reconstruct the frame in a decoder loop of the encoder.

By one example arrangement, encoding session(s) 1(212) may be established for each change in resolution or scaling that is to be provided, resulting in images (or actually frame sequences) 220 with different image sizes that can be provided to different end devices for viewing. Encoding session(s) 2 (214) may each be established to generate different bitrate changes thereby providing images 222 that establish different levels of quality and corresponding different computational loads. Encoding session(s) 3 (216) may provide data in different codec formats or standards such as HEVC or VP9 to name a couple of examples and that will establish images 224 that are compatible with different decoders and may offer different quality levels depending on the standard used. Encoding session(s) 4 (218) may use different frame rates generating images 226 provided at the different frame rates also to be compatible with certain decoders frame rate requirements, which also may establish differences in display quality. Many other examples for different encoding sessions may exist such for video processing such as de-interlacing, out of loop denoising, and so forth.

The result here is that this operation reduces or eliminates the need to perform writes specifically to place the supporting data into a sideband supporting data buffer. When the image data of the frames are written and then read for encoding, no extra write or read operations are performed above what would have occurred anyway with writing or reading the reserve areas of the pixel image data fields. This is true even when the supporting data is read multiple times for multiple encoding sessions.

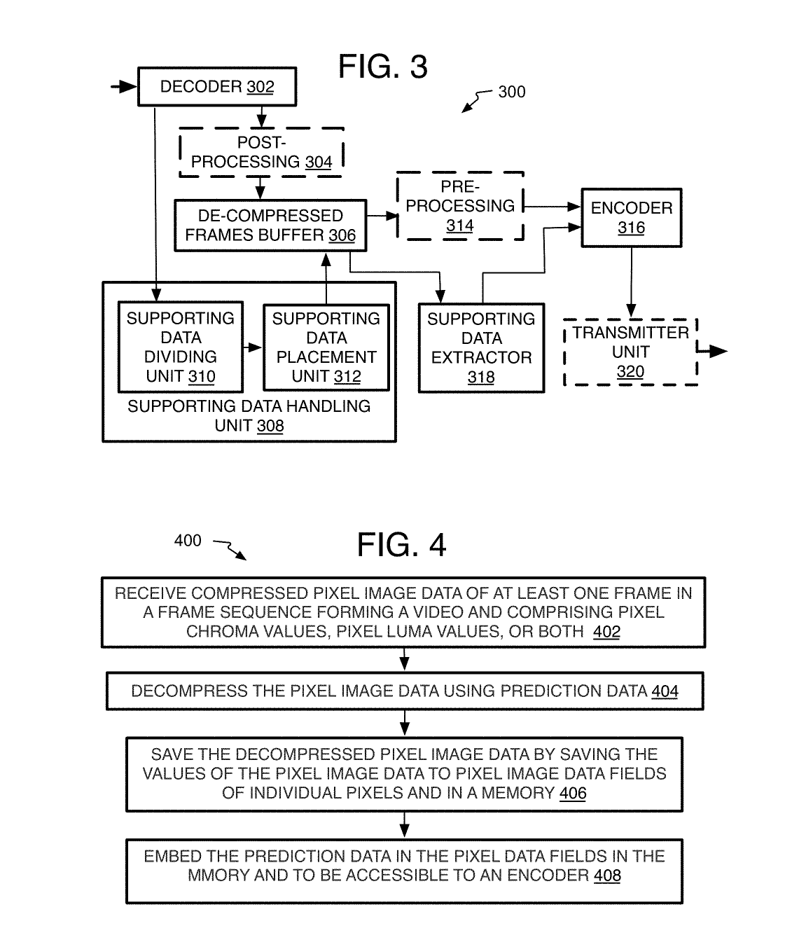

Referring to FIG. 3, in more detail, an example transcoder (or video coding system or device) 300 is arranged in accordance with at least some implementations of the present disclosure. The transcoder 300 may have a decoder 302, which here refers to a core decoder. The decoder 302 may receive a bitstream of compressed video data, and may perform de-entropy coding to generate readable values for one or more frames in a frame sequence where each frame is formed of the image data (the luma and/or chroma values) in addition to any supporting data which may include prediction data such as prediction mode and motion vectors, but could also include quantization data and/or other supporting data.

The decoder 302 may then perform inverse quantization and transform, and residual code assembly. Then frames of image data are reconstructed either by using intra-prediction or by adding inter-prediction based predictions to the residuals. Filtering is applied to the reconstructed rough frame to generate a final de-compressed frame. During inter-prediction, motion vectors from the initial supporting data are used to determine a matching block on a reference frame relative to a current block of image data being analyzed. The reconstructed frame also may be used as a reference frame for inter-prediction. Alternatively, the decoder 302 may have a motion estimation unit to perform decoder side motion estimation (DSME) to generate its own motion vectors. Either way, the inter-prediction-based candidate prediction along with any other candidate prediction is provided for prediction mode selection. Again, the initial prediction mode selection, i.e., which prediction mode should be used, may be obtained from the bitstream or generated at the decoder.

Once the de-compressed frames are available, the de-compressed frames may be provided to a post-processing unit 304 to apply any intermediate formatting adjustments that would apply to all video formats provided by the encoder. This also may include scaling or other adjustments when the transcoder is aboard a display device that provides the option to display the video without any further encoding. The post-processing after decoding also may include in-loop or normative noise reduction filtering for example. Thereafter, the de-compressed frames may be stored in a de-compressed (or non-compressed) frame buffer 306 where the image data of the frames is accessible to an encoder 316.

Also, once the prediction mode is selected to provide a final prediction for a block of image data, the prediction mode may be provided to a supporting data handling unit. When inter-prediction was the selected prediction mode, just the motion vector need be provided since this inherently indicates the prediction mode. Alternatively, when multiple inter-prediction modes are available, such as with alternative partitioning or reference frames, then the prediction mode may still be provided with the motion vector for a block of image data. The prediction data (and optionally other supporting data as described below) is provided to the supporting data handling unit 308, and specifically to a supporting data dividing unit 310 and a supporting data placement unit 312. The supporting data dividing unit 310 may concatenate the supporting data for a block and then divide the supporting data into pieces that will fit in the reserved areas of the pixel image data fields, such as 6 or 4 bit pieces. Normally, a single prediction data value could be longer than 4-6 bits, and therefore will fill the reserve areas of multiple consecutive pixel image data fields. The supporting data placement unit 312 then may place the pieces in a certain order into the pixel image data fields, such as raster order of pixels forming a macroblock that is assigned a motion vector on an image, but other orders could be used as well. By one form, this may include inserting the supporting data in the luma blocks, and particularly inserting the supporting data in a block of image data for which the embedded supporting data is to be applied to reconstruct that block during the decoding loop at an encoder. The details are provided below. The frames of image data with the embedded supporting data may be placed in the de-compressed frames buffer (or non-compressed image data buffer) 306.

As frames are placed in the de-compressed frames buffer 306, or shortly thereafter, the frames may be read, and pre-processing may be applied by a pre-processing unit 314. The pre-processing unit 314 may be considered part of the individual encoding sessions, and the encoder 316 applies core encoding to compress the formatted data. Thus, the pre-processing unit 314 may apply the chroma sampling, resolution, frame rate, and other changes that can be performed before core encoding. Otherwise, these changes as well as others that are applied during core encoding such as bitrate or codec format changes could be considered to be applied by a controller of the core encoder 316.

A supporting data extractor unit 318, which may or may not be considered a part of the supporting data handling unit 308, extracts or retrieves the embedded supporting data including, by one example, at least prediction data such as motion vectors and prediction mode selection. The data is then concatenated in a predetermined order, such as raster order within macroblocks, thereby concatenating the individual pieces that were placed in the reserve areas of the pixel image data fields. The supporting data then may be reconstructed from the concatenated supporting data.

Once the supporting values are reconstructed and pre-processing is applied as needed, the supporting data values are provided to the encoder 316. The encoder 316 then partitions the frames into blocks, slices and any other desired divisions, and may include alternative block arrangements for HEVC coding for example. The encoder then transforms and quantizes residuals and other image data. The data, along with supporting data, is entropy coded and provided to a transmitter unit 320 that places the encoded data in a bitstream and may include any multiplexing that may take place.

The encoder 316 also performs a prediction loop or decoder loop to reconstruct frames from the compressed data to determine predictions and residuals to be sued for compressing the original image data. Thus, the compressed frames are de-transformed and de-quantized with the resulting residuals assembled and added to predictions to reconstruct the partitions of the frames. The frames are then filtered and provided as reference frames for inter-prediction.

Applying the extracted supporting data, the extracted motion vectors may be used instead of performing motion estimation and may be provided directly to a motion compensation unit to generate a prediction block for a current block being analyzed. Alternatively, the extracted motion vectors may be used to emphasize a frame area to be searched on a reference frame to reduce the computational load of a final motion vector search during motion estimation when there is not high confidence on the accuracy of the extracted motion vectors. Either way, the extracted prediction mode may be used for the current block so that prediction mode selection computations may be skipped, and the prediction of the selected mode is provided to determine a residual to be compressed and to add to the residual generated on the decoder loop of the encoder 316. These operations reduce or eliminate the need to perform extra memory reads from a separate supporting data sideband buffer, significantly reducing memory bandwidth usually consumed by motion estimation and prediction mode selection.

In some examples, video processing system 300 may include additional items that have not been shown in FIG. 3 for the sake of clarity. For example, video processing system 300 may include a processor, a radio frequency-type (RF) transceiver, splitter and/or multiplexor, and/or an antenna. Further, video processing system 300 may include additional items such as a speaker, a microphone, an accelerometer, memory, a router, network interface logic, and so forth. Such implementations are shown with system 1000, 1100, and/or 1200 described below.

As used herein, the term “coder” may refer to an encoder and/or a decoder. Similarly, as used herein, the term “coding” may refer to encoding via an encoder and/or decoding via a decoder. A coder, encoder, or decoder may have components of both an encoder and decoder.

Referring to FIG. 4, an example process 400 is arranged in accordance with at least some implementations of the present disclosure. In general, process 400 may provide a computer-implemented method of video coding with reduced supporting data sideband buffer usage, and process 400 relates to the operations at a decoder side of a transcoder. In the illustrated implementation, process 400 may include one or more operations, functions or actions as illustrated by one or more of operations 402 to 408 numbered evenly. By way of non-limiting example, process 400 may be described herein with reference to operations discussed with respect to example systems 100, 200, 300, or 900 of FIGS. 1-3 and 9 respectively, and where relevant.

Process 400 may include “receive compressed pixel image data of at least one frame in a frame sequence forming a video and comprising pixel chroma values, pixel luma values, or both” 402, and as mentioned above, a bitstream of compressed image data may be received including pixel luma values and/or pixel chroma values. The image data otherwise may be in form ready for decoding in a certain format, and may be provided in the form of defined frames of image data and partitions within the frames.

Process 400 may include “decompress the pixel image data using prediction data” 404. Here, prediction data, whether provided in a bitstream with the pixel image data or generated by using decoder side motion estimation or obtained by other methods, may be used during decoding to apply inter-prediction to form prediction blocks by using motion vectors for example. The prediction data also may include prediction modes selected for a block at an encoder transmitting the bitstream or may be generated by the decoder. Other prediction data that may be included could be related to reference frames being used, and other supporting data may be used as described below. As to the prediction data, the prediction mode selection is a determination as to which prediction among a set of candidate predictions is to be added to the residual extracted from the compressed bitstream to reconstruct a block of image data for a frame.

Process 400 may include “save the decompressed pixel image data by saving the values of the pixel image data individually to pixel image data fields of individual pixels and in a memory” 406. As mentioned, individual luma and/or chroma values are saved in pixel image data fields. By one form, 10 or 12 bit HDR UHD values are saved in aligned 16 bit pixel image data fields so that 6 or 4 bit empty reserved spaces are formed in individual pixel image data fields.

Process 400 may include “embed the prediction data in the pixel image data fields in the memory and to be accessible to an encoder” 408. Thus, the supporting data such as the prediction data, but could be other types of supporting data, are divided into pieces that fit in the previously empty reserve areas of the pixel image data fields. By one form, the motion vector data, such as x and y magnitude data, and starting coordinate location (if needed), and/or prediction mode selections, which may be a single character code, and other supporting data are concatenated and then divided into 4 or 6 bit, or other size, pieces that fit in the reserve area of individual pixel image data fields. Each pixel image data field also stores a single image data value. By one form, in order to track the storage locations of the pieces, the pieces are stored in raster order of a block of data, such as a macroblock (16×16 pixels). By one approach, the prediction data for a macroblock may fill about 64 bytes, which is easily held in a single luma macroblock of image data in a YUV color space layout (or plane or domain). Chroma U and V blocks could be used if the luma Y blocks become filled, although that should be a rare occurrence for specialized situations. The details are provided below.

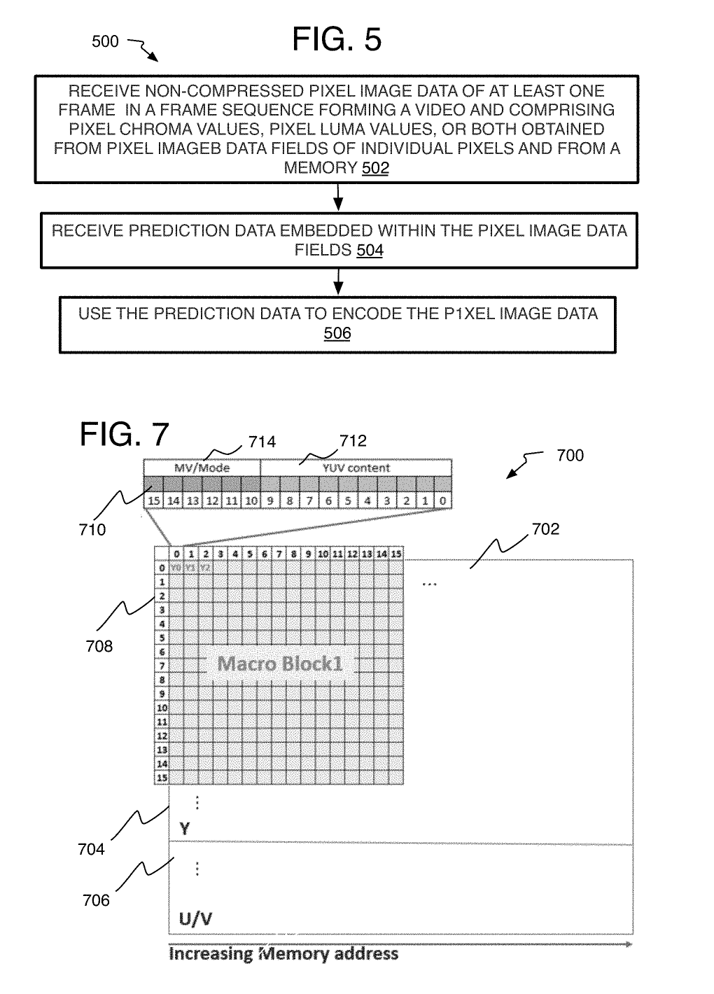

Referring to FIG. 5, an example process 500 is arranged in accordance with at least some implementations of the present disclosure. In general, process 500 may provide a computer-implemented method of video coding with reduced supporting data sideband buffer usage, where process 500 is related to operations at the encoder side of a transcoder. In the illustrated implementation, process 500 may include one or more operations, functions or actions as illustrated by one or more of operations 502 to 506 numbered evenly. By way of non-limiting example, process 500 may be described herein with reference to operations discussed with respect to example systems 100, 200, 300, or 900 of FIGS. 1-3 and 9 respectively, and where relevant.

Process 500 may include “receive non-compressed pixel image data of at least one frame in a frame sequence forming a video and comprising pixel chroma values, pixel luma values, or both obtained from pixel image data fields of individual pixels and from a memory” 502, and as mentioned above, after decompression at a transcoder for example, de-compressed image data may be stored in a non-compressed image data buffer or other memory accessible to an encoder. The encoder, or particularly by one example, a pre-processing unit for the encoder, may obtain the pixel image data from pixel image data fields, such as the 16 bit aligned fields for example.

Process 500 may include “receive prediction data embedded within the pixel image data fields” 504. Here, the prediction data, which may include motion vector data and/or prediction mode selection data, and/or other supporting data as mentioned herein, may be obtained from the reserved area in the pixel image data fields, and in the luma image data by one form. The prediction data may be obtained in raster order in a macroblock or other block of image data on a frame, and for multiple blocks in a frame. The prediction data may be stored in the block for which it is associated with, or in other words, the encoder will apply the prediction data to the image data of the same block where the prediction data is stored. Once received, the prediction data may be concatenated into a chain or string of bits in order as stored with the block of image data, and the prediction values then may be obtained from the chain. Thus, a single prediction or supporting data value may fill multiple consecutive pixel image data field reserve areas during storage.

Process 500 may include “use the prediction data to encode the pixel image data” 506. Once the prediction data is obtained by an encoder, motion vectors from the prediction data may be used to determine prediction blocks to be differenced from the image data of the original blocks to form residuals to be compressed. This occurs for those blocks where the prediction mode is selected as inter-prediction. Since the presence of a motion vector stored with a block of image data indicates the prediction mode is inter-prediction for that block, no prediction mode indicator needs to be stored with the block image data unless multiple inter-prediction modes are available. Otherwise, the prediction mode is provided by the prediction data embedded with the image data, or if omitted, the prediction mode may be determined by the encoder by analyzing one or more candidate predictions.

By one alternative, the prediction data may not be considered sufficiently precise to entirely replace motion estimation with the motion vector from the embedded prediction data. In this case, the location of a motion vector end point on a reference frame indicated by a motion vector from the embedded prediction data may be used to reduce the search parameters for matching blocks to determine a final motion vector. The details are provided below.

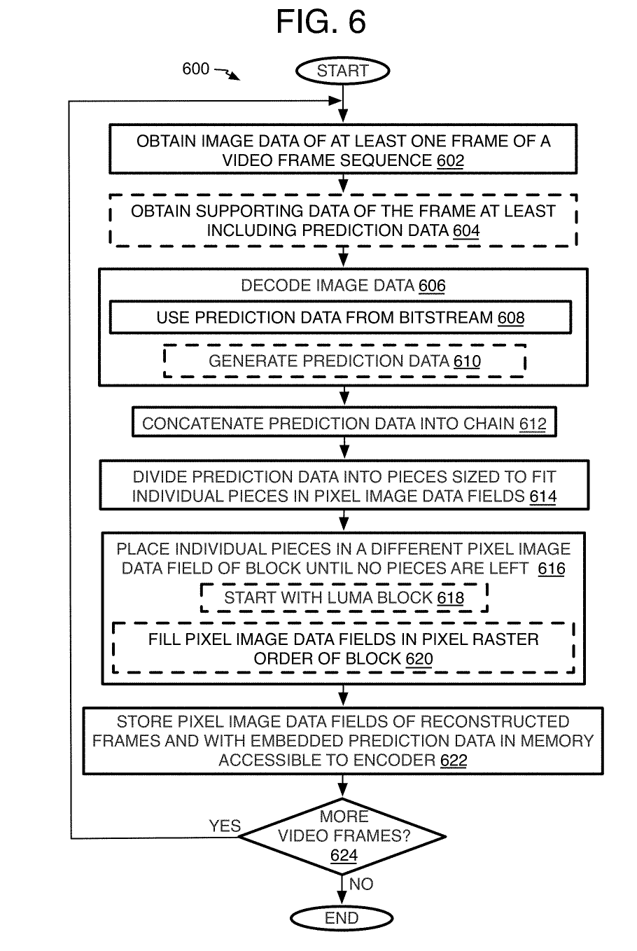

Referring now to FIG. 6, a detailed example process 600 is arranged in accordance with at least some implementations of the present disclosure. In general, process 600 may provide a computer-implemented method of video coding with reduced supporting data sideband buffer usage, and from the perspective of the decoder side of a transcoder. In the illustrated implementation, process 600 may include one or more operations, functions or actions as illustrated by one or more of operations 602 to 624 numbered evenly. By way of non-limiting example, process 600 will be described herein with reference to operations discussed with respect to example systems 100, 200, 300 and 900 of FIGS. 1-3 and 9 respectively, and where relevant.

Process 600 may include “obtain image data of at least one frame of a video frame sequence” 602. This operation refers to compressed image data in a bitstream received by a decoder that is part of a transcoder that also has an encoder to re-compress and re-transmit a video for example. As mentioned, the transcoder may be located at a remote server or at a remote location operated by a subscription service that receives broadcast or other video for example, but could be some other remote location. A single video decoded and then encoded by the transcoder then may be transmitted in multiple video formats, whether one or more bitstreams, to the locations of end users. Alternatively, the transcoder may be located at the location of the end devices such as with a gateway or cable box at a business or home. In either case, televisions, computers, smartphones, and so forth on a LAN may be the end devices that receive one video sequence in a desired format. By another alternative form, the transcoder may be located on a mobile device or one of the end devices such as a smartphone or tablet that is retransmitting a video to a display such as a television as in a personal area network (PAN), or it could be a set top box or television cable box that retransmits video to a television. Many other examples are possible.

The obtained image data may include pixel luma data, pixel chroma data, or both, and in YUV color space domain. The YUV data may have originally been in RGB color space and converted to YUV at an encoder specifically for efficiency during video coding. Also, the video may be formatted for HDR HD or UHD format where each luma or pixel value is 10 or 12 bits, but may be other sizes as explained below. The transcoder may extract the image data from the bitstream in the form of frames, and saves the compressed image data in a memory such as RAM or cache, and may hold the frames of image data in a compressed frame buffer that is ideally filled and emptied based upon a desired frame rate. The decoder fetches the frames from such a buffer depending on the frame rate, specified order such as a first-in, first-out (FIFO) related order, and other requirements of the decoder.

Process 600 optionally may include “obtain supporting data of the frame at least including prediction data” 604. The bitstream also may include initial supporting data such as prediction data including motion vector data and/or prediction mode selection data, but also could include quantization settings, partition definitions of frames, filter settings, reference frame data, and other supporting data. The term initial or original supporting data is used here merely to differentiate the supporting data provided to the transcoder versus the supporting data embedded with the de-compressed image data being passed from decoder to encoder within the transcoder. Initial supporting data of the frames are also placed in a memory.

Process 600 may include “decode image data” 606, where the frames of the image data are obtained from memory, and are then processed. As mentioned above, this may include de-entropy coding, inverse quantization, inverse transform, residual assembly, and by addition to predictions to reconstruct image data blocks of the frames. Then partition assembly and filtering may be applied to obtain a final frame of image data. The predictions are formed by using prediction data that is to be passed to the encoder for re-compressing the image data.

Most relevant here, the prediction data must first either be obtained or generated by the decoder. Thus, process 600 may include “use prediction data from bitstream” 608, and uses the motion vectors that were received in an initial bitstream with the compressed image data as well as the starting or ending location of the motion vectors. Otherwise, this also may optionally include “generate prediction data” 610 when the decoder may have its own decoder side motion estimation (DSME) unit to generate its own motion vectors. Regarding the motion vectors, the x and y magnitude of the motion vector may be provided from the bitstream when motion vectors for a block are available. The starting location of the motion vector may be a location on a current frame so that the motion vector points to a reference frame (or vice versa). The identification of reference frames also may be provided in the supporting data of the received bitstream, or may be either predetermined by profile or other control settings for example, or may be generated by DSME. It should also be noted that motion vectors may be provided only for those blocks that had inter-prediction selected as the prediction mode of a block.

Also, a prediction mode selection for a block may be extracted from the bitstream that is received by the decoder and may be used to set the prediction mode at a block rather than determining which among alternative prediction candidates should be the final candidate prediction. Alternatively, the decoder may use a prediction mode selection unit to compute which candidate prediction should be used.

The prediction data that was used by the decoder can then be saved with the pixel image data as described as follows. By one form, prediction data that was provided to the decoder in the bitstream with the compressed image data, but was not used to de-compress the image data, is not saved and passed on to the encoder.

To store the prediction data that was used by the decoder and for re-use by the encoder while eliminating or reducing the need for a supporting data sideband buffer, process 600 may include “concatenate prediction data into chain” 612. This refers to first obtaining the prediction data that was actually used and is needed at the encoder to generate the same predictions for a block as that generated at the decoder. For those blocks that have inter-prediction selected as the prediction mode, the x and y magnitude of the motion vector is saved but the prediction mode selection itself may be omitted since it is obvious from the presence of the motion vector data. Other blocks with different prediction modes that are not inter-prediction, such as intra-prediction, zero motion vector (ZMV), skip, or other prediction modes, may be indicated in the saved prediction mode of a block as well. A block may still have a saved prediction mode even though the prediction mode is inter-prediction when there are alternative possible inter-prediction modes which may include alternative reference frame or searching algorithm arrangements. The intra-prediction also may have alternatives that should be indicated.

By one form, a single code value (whether a number, letter, or other code) may be used to indicate each of the possible prediction mode alternatives, and only that code need be saved in the pixel image data fields for a block. For example, the prediction mode alternatives could simply be numbered 1 to N, where each number may be stored in binary or hexadecimal to be looked up on a table and by the encoder to determine which prediction mode to use for a block of image data. The maximum x and y magnitudes of the motion vectors are each sized depending on the resolution provided by the video format, and therefore, each coordinate itself could be up to a maximum of 13 digits in binary for an 8K video format for example. It also could be a floating value for sub-pixel accuracy.

By one example, the prediction data for a block may consume up to about 64 bytes which includes motion vector x and y magnitudes for the block and/or the prediction mode code. Other items could be any data needed to perform the inter-prediction. This may include reference frame data such as the identification of the reference frame, and whether considered prediction data or other supporting data, the embedded data may include values used for computations or statistics such as pixel value averages or variations, quantization related values, partition identification values, and so forth. For 10 bit image data values (P010), a macroblock has 192 bytes of reserve spaces, and for 12 bit values (P012), a macroblock has 128 bytes so that there should not be a problem fitting the prediction data of a block into its own macroblock. As mentioned, the start or end location of the motion vector or location of the block for the prediction mode does not need to be saved here in addition to the motion vector magnitude values since prediction data will be saved with the image data of the block for which the prediction data is applied.

When multiple prediction data values are present for a block as with both x and y motion vector data values, the values are concatenated in some predetermined order such as first the x value and then the y value, and other prediction and supporting data can then be added at the end of the chain or string in some memorized order. The result is a prediction data chain or single string holding all prediction data (or supporting data) bits for a block.

Referring to FIG. 7, the process 600 then may include “divide prediction data into pieces sized to fit individual pieces in pixel image data fields” 614 and in other words, pieces that fit into the reserve area of each pixel image data field. As shown on FIG. 7, an image data surface or plane (or layout) 700 for a frame 702 of image data is shown. The layout 700 includes an area 704 of luma Y image values arranged in macroblocks 708. A chroma U and/or V area arranges the chroma image data in blocks which may vary in size depending on the chroma sampling scheme that is used for a video being coded. For each square shown in the macroblock 708 of luma data Y0 to Y255 (just Y0 to Y2 is labeled), a pixel image data field 710 is provided. By one form, and as mentioned above, each field 710 holds 16 bits to be aligned in a memory or non-compressed image data buffer although other sizes could be used. The field 710 may include YUV content space 712 which holds a 10 or 12 bit value by one example. The remaining space in each field 710 is a reserve area 714 that now is used to hold prediction data as explained herein, and titled here as a MV/Mode space or prediction data area. Also as mentioned, the prediction data area 714 may be 6 bits when the pixel image data value is 10 bits, and 4 bits when the pixel image data value is 12 bits. It is understood, however, different bit sizes could be used for the reserve area 714, content area 712, and pixel image data value itself.

To prepare the prediction data for placement into the reserve areas of the pixel image data fields, the concatenated chain or string of prediction data is then divided up into pieces that fit within each reserve area and in a logical order, from a beginning to an end of the chain for instance that can be reversed. By one form, the pieces are 4 or 6 bits as explained above.

Process 600 then may include “place individual pieces in a different pixel image data field of block until no pieces are left” 616. This may include “start with luma blocks” 618, where the prediction is placed in the reserve areas of the pixel image data fields of the luma blocks. The U and V blocks may be used once the luma block is filled, but should not be needed as mentioned above. The filling of the reserve areas also may be performed in a logical order. Thus, process 600 may include “fill pixel image data fields in pixel raster order of block” 620, or in other words, from left to right, and then row by row from top to bottom within the luma block, where the filling of reserve areas in each block starts over at the upper left corner pixel location of the block.

The filling of the pixel image data fields may be performed by a GPU that is decoding the bitstream and generating the pixel image data values so that the GPU may perform a single write operation to fill all 16 bits in the pixel image data fields first by writing in the just-generated pixel image data value and then writing the prediction value piece into the reserve area of the pixel image data field. The prediction data for a single block (such as a luma macroblock) is concatenated into a chain or single string as constructed before storing the pieces in the first place, and then divided into pieces during or just after the prediction data is used at the decoder so that when the GPU is ready to place a pixel image data value into a pixel image data field, the prediction data piece is ready to be placed into the reserve area of a pixel image data field just after placement of the pixel image data value into the field.

Process 600 may include “store pixel image data fields of reconstructed frames and with embedded prediction data in memory accessible to encoder” 622. The pixel image data fields may be stored in a non-compressed image data buffer on a RAM, but could be other type of memory. This is performed by a GPU performing the continuous write of 16 bits (or in other words, the memory bandwidth is 16 bits for the write). It will be appreciated that the 16 bit write (or write access) is performed whether or not the reserve bits are empty or filled with prediction data. Thus, writing the prediction data to the reserve areas does not consume any more memory bandwidth than what was going to be consumed in the first place with empty reserve areas. This also eliminates the need for an extra memory bandwidth that would be consumed, and as described above that could be up to GB of memory bandwidth, by eliminating an additional memory such as a supporting data sideband memory.

Process 600 then may include the query “more video frames?” 624 to determine if the last frame in a frame sequence of a video has been reached. If not, the next frame is obtained and the process repeats starting back at operation 602. If no more frames are to be processed, the decoder-side process 600 ends, and the encoder can now retrieve both the pixel image data and the prediction data as explained with encoder-side process 800.

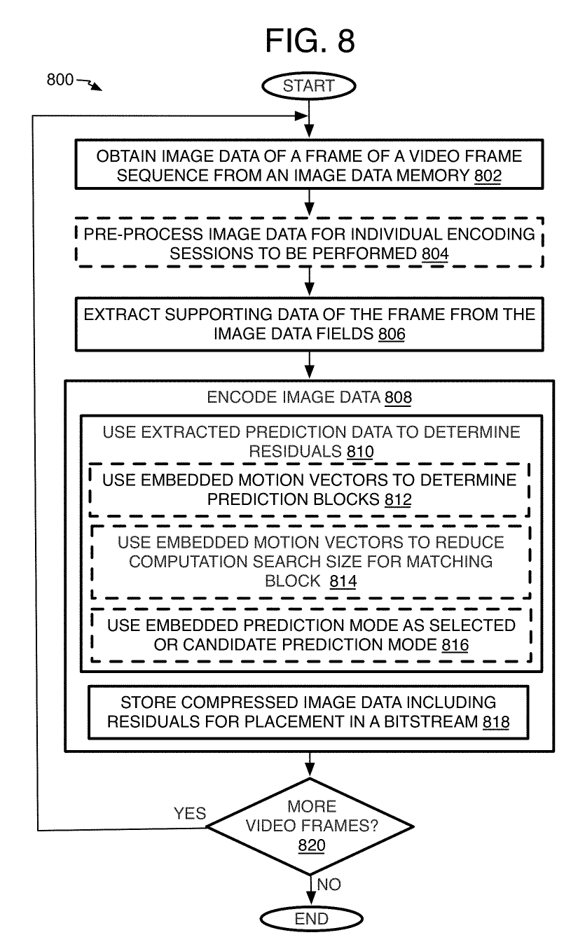

Referring now to FIG. 8, a detailed example process 800 is arranged in accordance with at least some implementations of the present disclosure. In general, process 800 may provide a computer-implemented method of video coding with reduced supporting data sideband buffer usage, and from the perspective of the encoder side. In the illustrated implementation, process 800 may include one or more operations, functions or actions as illustrated by one or more of operations 802 to 820 numbered evenly. By way of non-limiting example, process 800 will be described herein with reference to operations discussed with respect to example systems 100, 200, 300 and 900 of FIGS. 1-3 and 9 respectively, and where relevant.

Process 800 may include “obtain image data of a frame of a video frame sequence from an image data memory” 802. This involves obtaining image data for an encoder that may form the encoder side of a transcoder that has a decoder as well. Thus, this operation may involve obtaining de-compressed image data of video frames that were placed in memory by a decoder at the same device as the encoder, as described above, and where the image data saved is the luma and chroma values of the frames saved along with the embedded prediction data, but could additionally or alternatively include other supporting data used to de-compress the image data if desired and as described above with process 600. By one form, the memory is a non-compressed image data buffer. By one approach, the timing of the placement of frames into and out of the buffer may be carefully controlled so that encoding is performed in a just-in-time manner as the decoder is receiving a bitstream of video, decoding the image data of the video frames, and placing the de-compressed frames into the non-compressed image data buffer. In this case, the encoder may retrieve frames from the buffer ideally at a pace that is related to a desired frame rate of the encoder. The frame rate and other parameters may be set according to the requirements of decoders at end devices as well. The placement and retrieval of frames to and from such a buffer also may be based on a certain order such as first-in, first-out (FIFO) related order or others. Also as mentioned, the memory may be a RAM, cache, or other memory.

One example structure of pixel image data fields stored for each frame in a buffer may be indicated by layout 700 (FIG. 7) that shows the pixel image data fields 710 as described above, and that may be stored for individual per pixel luma values, and macroblock by macroblock of luma values in individual frames. It will be understood that different block sizes may be used, and that different storage scheme for embedding the supporting data rather than raster order, whether row or column based, could be used as well.

Also, the frames may be obtained or read from memory multiple times, one time for each different encoding session that is to be established for different video formats and/or video codec formats or standards to be used. As described with FIG. 2, this may include differences in resolution, chroma scheme, codec format or standard used whether HEVC or otherwise, bitrate, frame rate, or other video format or standard that may be used to meet the requirements of a remote device that will display the video and/or to provide optional scaling, quality, or enhancement layers to permit the adjustment of the quality level at a particular device.

Thus, when one or more encoding sessions are to be performed, process 800 may include “pre-process image data for each encoding session to be performed” 804. This may be performed before core encoding to adjust image data values to be compatible with a certain desired format thereby scaling the image data, to change the resolution of the frame for example, or otherwise changing the image data to the desired format. Other adjustments could be made during core encoding where parameters for quantization may be set to adjust bitrate for example. Many other examples are contemplated.

For each encoding session to be performed, process 800 also may include “extract supporting data of the frame from the image data fields” 806, where the extracted data includes prediction data, and by one form includes at least prediction data, and can include other supporting data, or may alternatively include other supporting data that is not prediction data as defined here, such as quantization related data, partitioning related data (to form blocks for any operation), filtering data, and so forth.

The extraction may be carried out by a GPU for example, by performing a single continuous read of a 16 bit pixel image data field where the image data value is read first and processed, and then the reserve area, such as reserve area 714 (FIG. 7), is read next and ideally immediately used for prediction calculations on the image data of the block it was saved with, and to determine a final prediction for the block, which is used in turn to reconstruct a frame as described herein.

More specifically, process 800 next may include “encode image data” 808. This may include first performing any necessary partitioning of the image data of the frames into blocks, slices, and/or any other prediction blocks. Then, residuals and image data are transformed, quantized, and entropy coded, while a decoding loop then performs inverse transform and quantization, partition building, filtering, to reconstruct reference frames for example, and then prediction generation as already described above. This may include at least performing inter-prediction but could also include intra-prediction or other prediction modes to generate candidate predictions. As mentioned when the prediction mode is indicated from the prediction data from the embedded supporting data, the prediction candidate corresponding to that prediction mode is used to determine a residual for the relevant prediction block.

When prediction data is included in the supporting data, this involves the process 800 performing “use extracted prediction data to determine residuals” 810, and the prediction data is used to determine prediction blocks, that if corresponding to a selected prediction mode (which may be embedded as well, then may be used to form a residual. The details are as follows.

Process 800 may include “use embedded motion vectors to determine prediction blocks” 812. This involves providing the motion vector, as well as the block address from which the motion vector was extracted, to a motion compensation unit that generates the prediction block by using the motion vector. The motion compensation unit adds the motion vector magnitudes to the current block address for example, and then uses the reference block at the new address as the prediction block. In these cases, motion estimation, and the heavy computational load to perform motion estimation searching for matching blocks, may be omitted altogether resulting in a very significant savings in time and computational load on the processor(s). An indication of which frame is the reference frame to be used to provide a reference block for the current block being analyzed may be pre-determined as a standard parameter, or otherwise may be provided in the frame overhead with profile data for example, and as is known. The reference frame is usually determined per frame or slice rather than per block.

Alternatively, the motion vector data may be considered as a rough estimate and may not be considered sufficiently precise to be used to determine a prediction block. This is more likely to occur depending on the coding standard used at the decoder such as an older standard such as MPEG4, or due to other parameters at the decoder. In these cases, process 800 optionally may include “use embedded motion vectors to reduce computation search size for matching block” 814. Thus, the embedded motion vector is used as a starting point to find a matching prediction block on a reference frame and for a current block, which still may result in significant reduction in computational load and time for performing a search to match a current block of image data with a reference block on a reference frame. This may include many different things such as centering the search over the reference position indicated by the embedded motion vector or moving the search to at least cover this position. Thus, the search may cover an area of the frame, at the reference position, it may not have searched at all, or would not have concentrated on, thereby increasing the efficiency and accuracy of the search by this modification alone. The modifications also may include reducing the size of the search to some maximum pixel range from the reference position or to include the reference position while reducing the search in other areas of the frame. Otherwise, the modifications may include reducing the specific number of areas or samples to search within the total area to be searched. This could include reducing the number of rings to search in a concentric hierarchical search pattern for example, or reducing the number of samples for each ring, or reducing the number of patterns and/or samples in any other search pattern.

Process 800 may optionally include “use embedded prediction mode as selected or candidate prediction mode” 816. Accordingly, a prediction generated by using the prediction mode from the embedded data is used when the prediction mode is provided in the embedded prediction data, which may be intra-prediction (whether one or more alternative intra-prediction modes are available) or some other prediction mode as mentioned above. Also as mentioned, when motion vector data is embedded in a block, the selected prediction mode is inter-prediction for that block, and inter-prediction is then used for the final prediction generation for that block rather than analyzing candidates. Also as mentioned, a prediction mode still may be embedded and then used when multiple different inter-prediction modes are available as described above.

Process 800 then may include “store compressed image data including residuals for placement in a bitstream” 818. The generated prediction blocks are differenced from the original data, and the residuals then may be compressed and placed in a bitstream for transmission to a remote or connected device that will decode the bitstream and display the video.

Process 800 then may include the query “more video frames?” 820, and if there are more frames, the process loops to repeat at operation 802. Otherwise, if no more frames are left to encode, the encoding process ends.

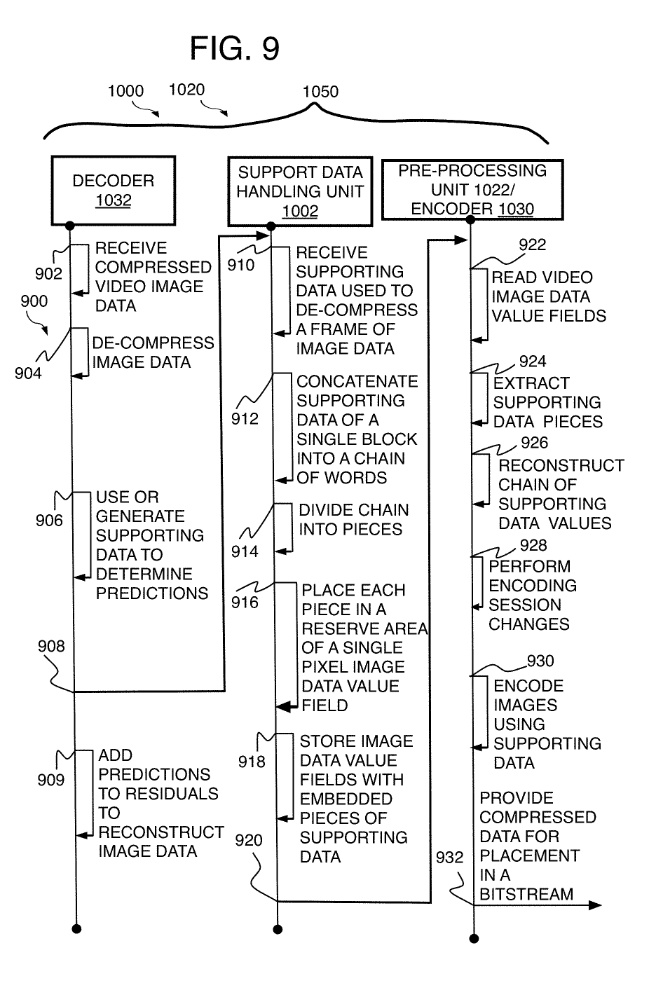

Referring now to FIG. 9, an image processing system 1000 may be used for an example process 900 of video coding with reduced supporting data sideband buffer usage shown in operation, and arranged in accordance with at least some implementations of the present disclosure. In the illustrated implementation, process 900 may include one or more operations, functions, or actions as illustrated by one or more of actions 902 to 932 numbered evenly, and used alternatively or in any combination. By way of non-limiting example, process 900 will be described herein with reference to operations discussed with respect to any of the implementations described herein where relevant.

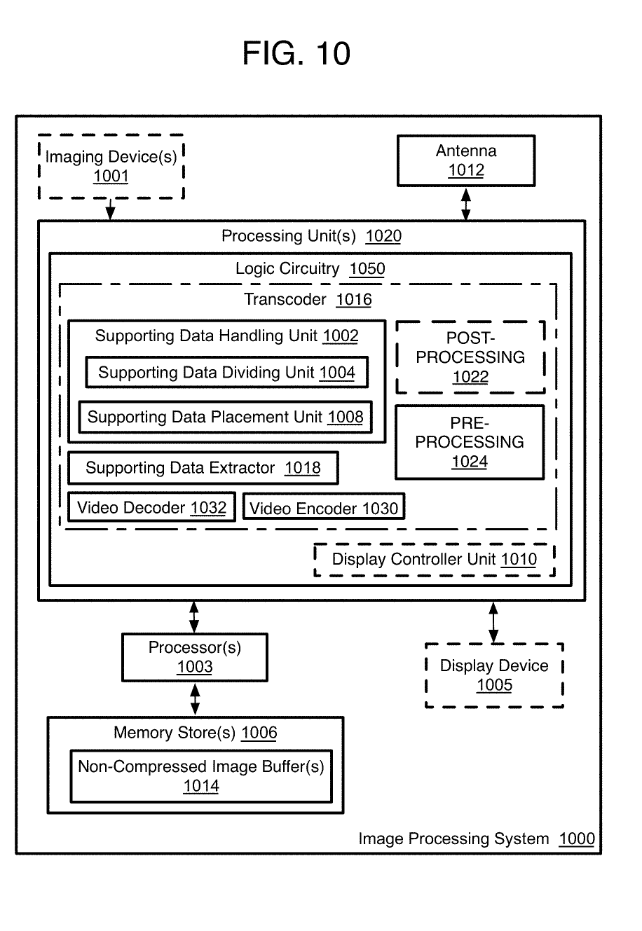

In the illustrated implementation, each system 1000 may include a processing unit(s) 1020 with logic units or logic circuitry or modules 1050, the like, and/or combinations thereof. For one example, logic circuitry or modules 1050 may include a transcoder 1016 that may include a supporting data handling unit 1002 that has at least a supporting data dividing unit 1004 and a supporting data placement unit 1008. A supporting data extractor unit 1018 may or may not be part of the supporting data handling unit 1002. The system 1000 also may include a video encoder 1030 and a video decoder 1032 as well as a pre-processing unit 1024 and post-processing unit 1022. Although process 1000, as shown in FIG. 10, may include one particular set of operations or actions associated with particular modules or units, these operations or actions may be associated with different modules than the particular module or unit illustrated here.

Process 900 may include “receive compressed video image data” 902. This is described above as receiving a bitstream of compressed image data of a video frame sequence, where this bit stream may or may not include supporting data such as prediction data described herein.

Process 900 may include “de-compress image data” 904. As mentioned above, the image data may be de-entropy coded, and then inverse transform and quantization is applied to reconstruct residuals. Predictions are then added to the residuals to reconstruct the image data of a frame.

Thus, process 900 then may include “use or generate supporting data to determine predictions” 906, and therefore, prediction data provided in the bitstream may be used, or the decoder may use DSME to generate its own motion vectors. Either the prediction mode is provided in the bitstream, or the prediction mode is selected by analyzing a group of candidate predictions. The details are explained above.

Process 900 then may include providing the supporting data to a support data handling unit in order to prepare the supporting data for storage with the image data in pixel image data fields described above. Meanwhile, process 900 may include adding predictions to residuals to reconstruct image data, as explained above, to generate the final de-compressed image data for the frames so that the de-compressed frames are ready for storage in memory such as a non-compressed image data or frame buffer.

Continuing with the process to store the supporting data obtained from the decoder in a memory, the process 900 may include “receive supporting data used to de-compress a frame of image data” 910, and “concatenate supporting data of a single block into a chain of words” 912. As explained above, all of the prediction data (and/or other supporting data) used for a block including motion vector data and/or prediction mode selection data is concatenated in a pre-determined order, such as x MV magnitude value, then y MV magnitude value, then prediction mode code if needed, placing one value after another value into a prediction chain or single string of bits. Also as mentioned, other supporting data could be additionally or alternatively chained as well as long as it is in a logical memorized order that can be reconstructed upon reading the memory.

The process 900 then may include “divide chain into pieces” 914, where each piece is sized to fit in the reserve area of a pixel image data field that holds a single pixel image data value (chroma or luma value). By one form, the luma fields are used first before chroma fields as described above, and the pieces are 4 or 6 bits each by one example, but could be other sizes. Typically, a single piece will be smaller than a supporting or prediction data value so that a single such value uses multiple pieces in consecutive pixel image data fields, and by one example, that are in raster order of the block (such as a macroblock) for which the supporting data is to be applied. It will be understood that other orders could be used, and supporting data may be stored in one or more blocks that are not used with the supporting data. This could be performed when the supporting data needs to be prepared before being applied to the image data. Thus, by one example, the supporting data may be stored a certain number of blocks in front of the block to use the supporting data. For instance, assuming the macroblocks are numbered in coding order, the prediction data stored in macroblock 1 maybe used to predict the image data of macroblock 4, with a uniform slip in application for the prediction data saved with each macroblock.

The process 900 then may include “place each piece in a reserve area of a single pixel image data value field” 916, and “store image data value fields with embedded pieces of supporting data” 918. Also as mentioned above, a GPU may perform one write to memory, such as a non-compressed image data buffer, for each 16 bit pixel image data field, and for the entire 16 bits whether or not the reserve area of the pixel image data field is empty or is storing supporting data. Thus, the writing of the supporting data to the reserve area of the pixel image data fields does not add memory bandwidth to the writing of the pixel image data fields, but desirably eliminates the need to perform an extra write to a supporting data sideband buffer, resulting in significant reduction in memory bandwidth as described above.

Once the de-compressed image data from the decoder is stored with the embedded supporting data, the process 900 then may switch 920 to the encoder side operations of a transcoder, and may include “read video image data value fields” 922, and read frame by frame, and within each frame, block by block (or other partition). Similar to the write, the read may also be performed by the GPU as a single operation to read the entire 16 bit (or other size) pixel image data field. Thus, the image data value may be read from the field so that processing with the image data value may be initiated, and the supporting data piece is read from the reserve area in the same field. Thus, cooperatively, process 900 may include “extract supporting data pieces” 924, and extracting each or individual pieces in a single luma block, in some order such as raster order, and by the present example, and then block by block for a frame.

Then, process 900 may include “reconstruct chain of supporting data values” 926, and to reconstruct the chain or string of pieces in order as stored in a block of luma data by concatenating the pieces in order. Once in order as a single chain, the supporting data values can be extracted (or read or identified) from the chain.

It will be noted that the read and reconstruction of the supporting data may occur multiple times, such as once each for a different encoding session that is to be performed.

Process 900 may include “perform encoding session changes” 928, which indicates the pre-processing operations that may be used to modify the image data to meet the parameters of a certain video coding format or standard. This may include resolution, chroma sampling scheme, or other scaling changes, bitrate or frame rate changes, preparation for other coding standard application (codec format), or other modifications. Then the image data may be provided for core encoding.

Process 900 may include “encode images using supporting data” 930, and as described above, the image data may be encoded using the supporting data. When the supporting data is prediction data, the motion vectors may be used to eliminate or reduce the amount of computational load to perform motion estimation. The prediction mode indicated by the embedded prediction data also may be used to set the prediction mode to be used for particular blocks in a frame. The details are provided above.

Process 900 may include “provide compressed data for placement in a bitstream” 932, and where the compressed data is ready for placement in a bitstream to be transmitted wirelessly, or by wire, to a remote or local display device for example. Of course, the compressed video could be stored for later use rather than immediate viewing as well.

While implementation of example process 300, 500, and/or 600 may include the undertaking of all operations shown in the order illustrated, the present disclosure is not limited in this regard and, in various examples, implementation of any of the processes herein may include the undertaking of only a subset of the operations shown and/or in a different order than illustrated.

In implementations, features described herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more features described herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the features described herein. As mentioned previously, in another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth. For example, a module may be embodied in logic circuitry for the implementation via software, firmware, or hardware of the coding systems discussed herein.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit also may utilize a portion of software to implement its functionality.

Referring to FIG. 10, an example image processing system 1000 for video coding with reduced supporting data sideband buffer usage may be arranged in accordance with at least some implementations of the present disclosure. System 1000 may be a transcoder or may be another computing device that has a transcoder such as mobile devices including smartphones or tablets that receive bitstreams of compressed videos and then may transmit re-compressed versions of the video to other devices for decompression and display such as televisions as is performed in LAN or personal area networks (PANs), or may be performed with set top or cable television boxes, and so forth. Many different examples are contemplated.

Depending on the type of computing device system 1000 provides, the system 1000 optionally may include an imaging device 1001 or may be connected to a separate imaging device 1001. By one form, the imaging device may be a video camera, still picture camera, or both, and the device 1000 holds such a camera such as a smartphone, tablet, and so forth. By other examples, the device 1000 is a camera, and the imaging device 1001 is the hardware and sensors that form the image capturing components of the camera.

Also depending on the type of computing device presented by system 1000, system 1000 may have or may be connected to a display device 1005, and may or may not have a display controller unit 1010 that receives image data and performs formatting and image data control to display a video. The display device 1005 may or may not be the display device used for displaying the video after being compressed by the encoder 1030 that is part of a transcoder 1016.

System 1000 also may include one or more central and/or graphics processing units or processors 1003 and one or more memory stores 1006. Central processing units 1003, memory store 1006, and/or display device 1005 may be capable of communication with one another, via, for example, a bus, wires, or other access. In various implementations, display device 1005 may be integrated in system 1000 or implemented separately from system 1000. The system 1000 also may have an antenna 1012 to receive or transmit compressed image data and other related data.

As shown in FIG. 10, and discussed above, the processing unit 1020 may have logic circuitry 1050 which may hold a transcoder 1016. The transcoder 1016 includes at least a video encoder 1030 and a video decoder 1032, but also may include a supporting data handling unit 1002. The supporting data handling unit 1002 may include a supporting data dividing unit 1004 and a supporting data placement unit 1008. A supporting data extractor 1018 also may be considered part of the transcoder, and may or may not be considered part of the supporting data handling unit 1002. The logic circuitry 1050, and optionally the transcoder 1016, also may include a post-processing unit 1022 and/or a pre-processing unit 1024. It will be understood that any of these units may not be a single separate module or unit but may include that code or programming spread throughout a number of units or modules but that is relevant to the use and control of that component.

As will be appreciated, the modules illustrated in FIG. 10 may include a variety of software and/or hardware modules and/or modules that may be implemented via software or hardware or combinations thereof. For example, the modules may be implemented as software via processing units 1020 or the modules may be implemented via a dedicated hardware portion. Furthermore, the shown memory stores 1006 may be shared memory for processing units 1020, for example. The de-compressed image data with embedded supporting data may be stored in a non-compressed image data Buffer(s) 1014 in memory 1006. This data as well as data to operate the units mentioned herein, however, may be stored on any of the options mentioned herein, or may be stored on a combination of these options, or may be stored elsewhere. Also, system 1000 may be implemented in a variety of ways. For example, system 1000 (excluding display device 1005) may be implemented as a single chip or device having a graphics processor, a quad-core central processing unit, and/or a memory controller input/output (I/O) module. In other examples, system 1000 (again excluding display device 1005) may be implemented as a chipset.

Processor(s) 1003 may include any suitable implementation including, for example, microprocessor(s), multicore processors, application specific integrated circuits, chip(s), chipsets, programmable logic devices, graphics cards, integrated graphics, general purpose graphics processing unit(s), or the like. By one form, processor(s) 1003 include a GPU to perform repetitive decoding and encoding tasks, and therefore, may be used to write and read image data including embedded supporting data to and from the non-compressed image data buffer(s) 1016. In addition, memory stores 1006 may include any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 1006 also may be implemented via cache memory or RAM, whether on-chip or off-chip.

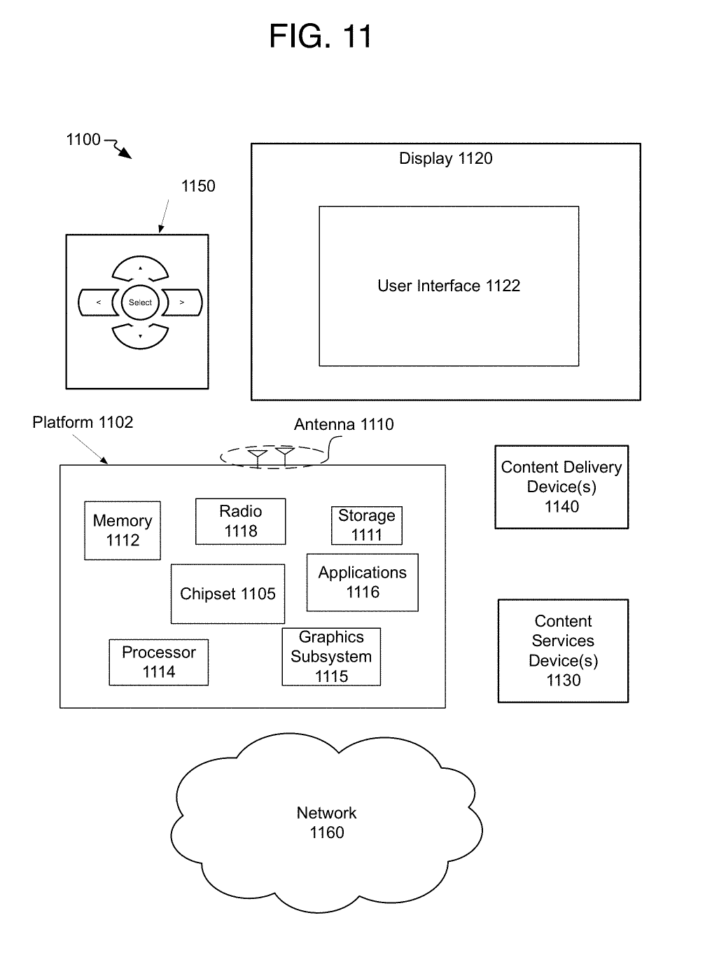

Referring to FIG. 11, an example system 1100 in accordance with the present disclosure and various implementations, may be a media system although system 1100 is not limited to this context. For example, system 1100 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 1100 includes a platform 1102 communicatively coupled to a display 1120. Platform 1102 may receive content from a content device such as content services device(s) 1130 or content delivery device(s) 1140 or other similar content sources. A navigation controller 1150 including one or more navigation features may be used to interact with, for example, platform 1102 and/or display 1120. Each of these components is described in greater detail below.

In various implementations, platform 1102 may include any combination of a chipset 1105, processor 1114, memory 1112, storage 1111, graphics subsystem 1115, applications 1116 and/or radio 1118 as well as antenna(s) 1110. Chipset 1105 may provide intercommunication among processor 1114, memory 1112, storage 1111, graphics subsystem 1115, applications 1116 and/or radio 1118. For example, chipset 1105 may include a storage adapter (not depicted) capable of providing intercommunication with storage 1111.

Processor 1114 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1110 may be dual-core processor(s), dual-core mobile processor(s), and so forth.

Memory 1112 may be implemented as a volatile memory device such as, but not limited to, a Random Access Memory (RAM), Dynamic Random Access Memory (DRAM), or Static RAM (SRAM).

Storage 1111 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1111 may include technology to increase the storage performance enhanced protection for valuable digital media when multiple hard drives are included, for example.

Graphics subsystem 1115 may perform processing of images such as still or video for display. Graphics subsystem 1115 may be a graphics processing unit (GPU) or a visual processing unit (VPU), for example. An analog or digital interface may be used to communicatively couple graphics subsystem 1115 and display 1120. For example, the interface may be any of a High-Definition Multimedia Interface, Display Port, wireless HDMI, and/or wireless HD compliant techniques. Graphics subsystem 1115 may be integrated into processor 1114 or chipset 1105. In some implementations, graphics subsystem 1115 may be a stand-alone card communicatively coupled to chipset 1105.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In other implementations, the functions may be implemented in a consumer electronics device.

Radio 1118 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1118 may operate in accordance with one or more applicable standards in any version.

In various implementations, display 1120 may include any television type monitor or display. Display 1120 may include, for example, a computer display screen, touch screen display, video monitor, television-like device, and/or a television. Display 1120 may be digital and/or analog. In various implementations, display 1120 may be a holographic display. Also, display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, platform 1102 may display user interface 1122 on display 1120.

In various implementations, content services device(s) 1130 may be hosted by any national, international and/or independent service and thus accessible to platform 1102 via the Internet, for example. Content services device(s) 1130 may be coupled to platform 1102 and/or to display 1120. Platform 1102 and/or content services device(s) 1130 may be coupled to a network 1160 to communicate (e.g., send and/or receive) media information to and from network 1160. Content delivery device(s) 1140 also may be coupled to platform 1102 and/or to display 1120.

In various implementations, content services device(s) 1130 may include a cable television box, personal computer, network, telephone, Internet enabled devices or appliance capable of delivering digital information and/or content, and any other similar device capable of unidirectionally or bidirectionally communicating content between content providers and platform 1102 and/display 1120, via network 1160 or directly. It will be appreciated that the content may be communicated unidirectionally and/or bidirectionally to and from any one of the components in system 1100 and a content provider via network 1160. Examples of content may include any media information including, for example, video, music, medical and gaming information, and so forth.

Content services device(s) 1130 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1102 may receive control signals from navigation controller 1150 having one or more navigation features. The navigation features of controller 1150 may be used to interact with user interface 1122, for example. In implementations, navigation controller 1150 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1150 may be replicated on a display (e.g., display 1120) by movements of a pointer, cursor, focus ring, or other visual indicators displayed on the display. For example, under the control of software applications 1116, the navigation features located on navigation controller 1150 may be mapped to virtual navigation features displayed on user interface 1122, for example. In implementations, controller 1150 may not be a separate component but may be integrated into platform 1102 and/or display 1120. The present disclosure, however, is not limited to the elements or in the context shown or described herein.

In various implementations, drivers (not shown) may include technology to enable users to instantly turn on and off platform 1102 like a television with the touch of a button after initial boot-up, when enabled, for example. Program logic may allow platform 1102 to stream content to media adaptors or other content services device(s) 1130 or content delivery device(s) 1140 even when the platform is turned “off” In addition, chipset 1105 may include hardware and/or software support for 7.1 surround sound audio and/or high definition (7.1) surround sound audio, for example. Drivers may include a graphics driver for integrated graphics platforms. In implementations, the graphics driver may comprise a peripheral component interconnect (PCI) Express graphics card.

In various implementations, any one or more of the components shown in system 1100 may be integrated. For example, platform 1102 and content services device(s) 1130 may be integrated, or platform 1102 and content delivery device(s) 1140 may be integrated, or platform 1102, content services device(s) 1130, and content delivery device(s) 1140 may be integrated, for example. In various implementations, platform 1102 and display 1120 may be an integrated unit. Display 1120 and content service device(s) 1130 may be integrated, or display 1120 and content delivery device(s) 1140 may be integrated, for example. These examples are not meant to limit the present disclosure.

In various implementations, system 1100 may be implemented as a wireless system, a wired system, or a combination of both. When implemented as a wireless system, system 1100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1102 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 11.

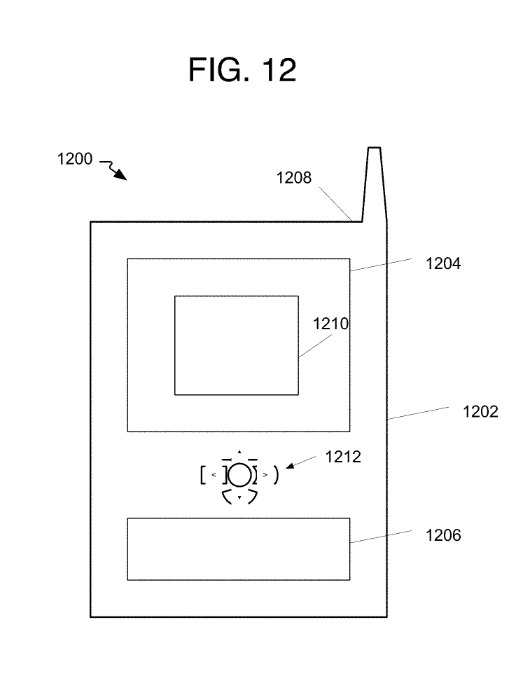

As described above, system 1000 or 1100 may be implemented in varying physical styles or form factors. FIG. 12 illustrates implementations of a small form factor device 1200 in which system 1000 or 1100 may be implemented. In implementations, for example, device 1200 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 12, device 1200 may include a housing 1202, a display 1204, an input/output (I/O) device 1206, and an antenna 1208. Device 1200 also may include navigation features 1212. Display 1204 may include any suitable screen 1210 on a display unit for displaying information appropriate for a mobile computing device. I/O device 1206 may include any suitable I/O device for entering information into a mobile computing device. Examples for I/O device 1206 may include an alphanumeric keyboard, a numeric keypad, a touch pad, input keys, buttons, switches, rocker switches, microphones, speakers, voice recognition device and software, and so forth. Information also may be entered into device 1200 by way of microphone (not shown). Such information may be digitized by a voice recognition device (not shown). The implementations are not limited in this context.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects described above may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

By one example, a computer-implemented method of video coding comprises receiving compressed pixel image data of at least one frame in a frame sequence forming a video and comprising pixel chroma values, pixel luma values, or both; decompressing the pixel image data using prediction data; saving the decompressed pixel image data by saving the values of the pixel image data individually to pixel image data fields of individual pixels and in a memory; and embedding the prediction data in the pixel image data fields in the memory and to be accessible to an encoder.

By another example, the method also may include wherein the prediction data comprises motion vector data, prediction mode selection data, or both; wherein the pixel image data fields are 16 bits, and a pixel value within the field uses 10 or 12 bits, and the prediction data uses the remaining 6 or 4 bits in the pixel image data fields; wherein the prediction data comprises at least one single value that fills a reserve area of multiple pixel image data fields; wherein the prediction data fills reserve areas of the pixel image data fields in raster order corresponding to the location of the pixels in a block of pixels; wherein the pixel image data fields hold luma pixel image data of a YUV color space; wherein no separate prediction data buffer is used to hold prediction data separately from pixel image chroma or luma data to transfer the prediction data from a decoder to an encoder when the prediction data is embedded in the pixel image data fields; and the method comprising: concatenating the prediction data; dividing the prediction data into pieces that fit into reserve areas of the individual pixel image data fields; and placing each piece of prediction data to be applied to a block of pixel image data into a different pixel image data field of the block.

By one example, another computer-implemented method of video coding comprises receiving non-compressed pixel image data of at least one frame of a frame sequence forming a video and comprising pixel chroma values, pixel luma values, or both obtained from pixel image data fields of individual pixels and from a memory; receiving prediction data embedded within the pixel image data fields; and using the prediction data to encode the pixel image data.

By another example, this method also may include wherein the prediction data is placed in one of Y, U, or V pixel image data fields until filled before filling the pixel image data fields of one of the other of the Y, U, or V pixel image data fields to store the prediction data; the method comprising dividing values of the prediction data into 4 or 6 bit pieces to place into the pixel image data fields; and placing the prediction data into pixel image data fields of a block of pixels that uses the prediction data to encode the block, wherein the prediction data is associated with macroblocks, and is embedded starting at a first upper left pixel of individual macroblocks; reading both the image data value and piece of a prediction data value from a single read of the pixel image data fields; concatenating the prediction data fields in an order corresponding to pixel locations to form a string of prediction data; and determining prediction data values from the string.

In a further example, a computer-implemented system of video coding comprises a decoder that provides prediction data used to de-compress compressed image data; a non-compressed frame buffer used to store de-compressed image data from the decoder with individual pixel image chroma or luma values each in a pixel image data field and prediction data embedded within a reserve area of the pixel image data fields; and an encoder to receive the prediction data from the pixel image data fields to re-compress the de-compressed image data.

The system also may comprise wherein the prediction data comprises motion vector data, prediction mode selection data, or both; wherein the motion vector data comprises x and y magnitude components of the motion vector and is associated with a starting location of the motion vector; wherein the system comprises a supporting data handling unit that receives both an image data value and piece of a prediction data value with a single read of a pixel image data field; wherein the supporting data handling unit concatenates pieces of prediction data in order as saved in a block of image data to form a chain of prediction data values; and extracts the prediction data values form the chain; wherein the pieces are placed in raster order in pixel image data fields corresponding to pixel positions within a block of image data; wherein the encoder receives the same prediction data embedded within the same pixel image data fields multiple times, each for a different encoding session wherein at least one encoding session provides a different video format, standard, or parameters than at least one other encoding session.

In another approach, a computer-readable medium having instructions stored thereon that when executed by a computing device cause the computing device to be operated by: receiving compressed pixel image data of at least one frame in a frame sequence forming a video and comprising pixel chroma values, pixel luma values, or both; decompressing the pixel image data using prediction data; saving the decompressed pixel image data by saving the values of the pixel image data individually to pixel image data fields of individual pixels and in a memory; and embedding the prediction data in the pixel image data fields in the memory and to be accessible to an encoder.

In another example, the instructions may cause the computing device to include wherein the prediction data comprises motion vector data, prediction mode selection data, or both; wherein the pixel image data fields are 16 bits, and a pixel value within the field uses 10 or 12 bits, and the prediction data uses the remaining 6 or 4 bits in the pixel image data fields; wherein the prediction data comprises at least one single value that fills a reserve area of multiple pixel image data fields; wherein the prediction data fills reserve areas of the pixel image data fields in raster order corresponding to the location of the pixels in a block of pixels; wherein the pixel image data fields hold luma pixel image data of a YUV color space; wherein no separate prediction data buffer is used to hold prediction data separately from pixel image chroma or luma data to transfer the prediction data from a decoder to an encoder when the prediction data is embedded in the pixel image data fields; and for the instructions to cause the computing device to be operated by concatenating the prediction data; dividing the prediction data into pieces that fit into reserve areas of the individual pixel image data fields; and placing each piece of prediction data to be applied to a block of pixel image data into a different pixel image data field of the block.

In yet another example, an apparatus may include means for performing the methods according to any one of the above examples.

In another example, at least one machine readable medium comprises a plurality of instructions that in response to being executed on a computing device, causes the computing device to perform any of the methods described herein.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

1-25. (canceled)

26. A computer implemented method of video coding comprising:
receiving compressed pixel image data of at least one frame in a frame sequence forming a video and comprising pixel chroma values, pixel luma values, or both;
decompressing the pixel image data using prediction data;
saving the decompressed pixel image data by saving the values of the pixel image data individually to pixel image data fields of individual pixels and in a memory; and
embedding the prediction data in the pixel image data fields in the memory and to be accessible to an encoder.

27. The method of claim 26 wherein the prediction data comprises motion vector data, prediction mode selection data, or both.

28. The method of claim 26 wherein the pixel image data fields are 16 bits, and a pixel value within the field uses 10 or 12 bits, and the prediction data uses the remaining 6 or 4 bits in the pixel image data fields.

29. The method of claim 26 wherein the prediction data comprises at least one single value that fills a reserve area of multiple pixel image data fields.

30. The method of claim 26 wherein the prediction data fills reserve areas of the pixel image data fields in raster order corresponding to the location of the pixels in a block of pixels.

31. The method of claim 26 wherein the pixel image data fields hold luma pixel image data of a YUV color space.

32. The method of claim 26 wherein no separate prediction data buffer is used to hold prediction data separately from pixel image chroma or luma data to transfer the prediction data from a decoder to an encoder when the prediction data is embedded in the pixel image data fields.

33. The method of claim 26 comprising:
concatenating the prediction data;
dividing the prediction data into pieces that fit into reserve areas of the individual pixel image data fields; and
placing each piece of prediction data to be applied to a block of pixel image data into a different pixel image data field of the block.

34. A computer implemented method of video coding comprising:
receiving non-compressed pixel image data of at least one frame of a frame sequence forming a video and comprising pixel chroma values, pixel luma values, or both obtained from pixel image data fields of individual pixels and from a memory;
receiving prediction data embedded within the pixel image data fields; and
using the prediction data to encode the pixel image data.

35. The method of claim 34 wherein the prediction data is placed in one of Y, U, or V pixel image data fields until filled before filling the pixel image data fields of one of the other of the Y, U, or V pixel image data fields to store the prediction data.

36. The method of claim 34 comprising dividing values of the prediction data into 4 or 6 bit pieces to place into the pixel image data fields.

37. The method of claim 34 comprising placing the prediction data into pixel image data fields of a block of pixels that uses the prediction data to encode the block.

38. The method of claim 34 wherein the prediction data is associated with macroblocks, and is embedded starting at a first upper left pixel of individual macroblocks.

39. The method of claim 34 comprising:
reading both the image data value and piece of a prediction data value from a single read of the pixel image data fields;
concatenating the prediction data fields in an order corresponding to pixel locations to form a string of prediction data; and
determining prediction data values from the string.

40. A computer implemented system for video coding comprising:
a decoder that provides prediction data used to de-compress compressed image data;
a non-compressed frame buffer used to store de-compressed image data from the decoder with individual pixel image chroma or luma values each in a pixel image data field and prediction data embedded within a reserve area of the pixel image data fields; and
an encoder to receive the prediction data from the pixel image data fields to re-compress the de-compressed image data.

41. The system of claim 40 wherein the prediction data comprises motion vector data, prediction mode selection data, or both.

42. The system of claim 41 wherein the motion vector data comprises x and y magnitude components of the motion vector and is associated with a starting location of the motion vector.

43. The system of claim 40 comprising a supporting data handling unit that receives both an image data value and piece of a prediction data value with a single read of a pixel image data field.

44. The system of claim 43 wherein the supporting data handling unit concatenates pieces of prediction data in order as saved in a block of image data to form a chain of prediction data values; and extracts the prediction data values form the chain.

45. The system of claim 44 wherein the pieces are placed in raster order in pixel image data fields corresponding to pixel positions within a block of image data.

46. The system of claim 40 wherein the encoder receives the same prediction data embedded within the same pixel image data fields multiple times, each for a different encoding session wherein at least one encoding session provides a different video format, standard, or parameters than at least one other encoding session.

47. The system of claim 40 comprising placing the prediction data into pixel image data fields of a block of pixels that uses the prediction data to encode the block.

48. The system of claim 40 wherein the prediction data is placed in one of Y, U, or V pixel image data fields until filled before filling the pixel image data fields of one of the other of the Y, U, or V pixel image data fields to store the prediction data.

49. A computer-readable medium having instructions thereon that cause a computing device to be operated by:
receiving compressed pixel image data of at least one frame in a frame sequence forming a video and comprising pixel chroma values, pixel luma values, or both;
decompressing the pixel image data using prediction data;
saving the decompressed pixel image data by saving the values of the pixel image data individually to pixel image data fields of individual pixels and in a memory; and
embedding the prediction data in the pixel image data fields in the memory and to be accessible to an encoder.

50. The computer-readable medium of claim 49 wherein the instructions cause the computing device to operate by:
concatenating the prediction data;
dividing the prediction data into pieces that fit into reserve areas of the individual pixel image data fields; and
placing each piece of prediction data to be applied to a block of pixel image data into a different pixel image data field of the block.
